(19) United States
(12) Patent Application Publication
(10) Pub. No.: US 2017/0201657 A1
(43) Pub. Date: Jul. 13, 2017

(54) BANDPASS FILTER WITH VARIABLE PASSBAND

(71) Applicant: APPLE INC., Cupertino, CA (US)

(72) Inventor: Ligang Wang, Cupertino, CA (US)

(21) Appl. No.: 14/991,960

(22) Filed: Jan. 10, 2016

(51) Int. Cl. H04N 5/225; G02B 5/28; G02B 5/22

(52) U.S. Cl. CPC H04N 5/2254; G02B 5/22; G02B 5/285

(57) ABSTRACT

An optical component includes an absorption-based filter having a selected cut-on wavelength and a multilayer interference filter, arranged in series with the absorption-based filter and having a passband containing the cut-on wavelength of the absorption-based filter.

### FIELD OF THE INVENTION

The present invention relates generally to optical components, and particularly to bandpass filters.

### BACKGROUND

Thin-film interference filters can be engineered to provide blocking and transmission in given wavelength ranges using techniques of design and manufacture that are known in the art. The wavelength response of such an interference filter changes as a function of the angle of incidence of light rays on the filter, wherein typically the spectral transmission band of the filter shifts toward shorter wavelengths as the angle of incidence increases. (The term “light” is used herein to refer broadly to optical radiation, which may be in the visible, ultraviolet, or infrared wavelength range.) This phenomenon of angular filter shift is described, for example, by Anderson et al., in “Angle-Tuned Thin-Film Interference Filters for Spectral Imaging,” Optics & Photonics News (January, 2011), pages 12-13, which is incorporated herein by reference. MacLeod provides further information on this subject in Thin-Film Optical Filters (Fourth Edition, 2010), and particularly in section 8.4.1, which is incorporated herein by reference.

The magnitude of the angular shift of the spectral transmission of a given filter is controlled by the effective index of refraction of the filter, n_{eff}. Typical values of n_{eff}are between 1.47 and 2. The lower the value of n_{eff}, the greater will be the spectral shift relative to the angle of incidence. The dependence of the spectral shift of transmission wavelength λ as a function of angle of incidence θ is expressed by the following formula, given by Anderson et al.:

$$λ ( θ ) = λ ( 0 ) \sqrt{1 - \frac{{sin}^{2} ( θ )}{{n}_{eff}^{2}}}$$

U.S. Pat. No. 3,825,350 describes a system for detecting and providing positional information on a source of monochromatic radiation at a given wavelength of interest. The system includes an angle sensitive detection subsystem, which varies its response as a function of angle of incidence of incident radiation, and an angle insensitive detection subsystem which has a uniform response for differing angles of incidence of incident radiation. The system utilizes a dielectric filter tuned to the given wavelength of interest which has the characteristic of varying its spectral filtering response as a function of the angle of incidence of radiation.

U.S. Pat. No. 4,705,356 describes a thin film optically variable article having substantial color shift with varying angle of light incidence and viewing and including an optically thick, substantially transparent element carrying a colorant and having first and second surfaces. A multilayer interference coating is carried on one of the first and second surfaces. The colorant serves to modify in essentially a subtractive mode the color at normal incidence and the color shift with angle of the multilayer interference coating as seen by reflection or transmission.

U.S. Pat. No. 4,293,732 describes a system for reducing ultraviolet radiation (UV), below the wavelength of 350 nm, arriving to a silicon solar cell. The primary UV-rejection is provided by an interference filter, with a cut-on edge around 350 nm. An absorption-based long-pass filter, with cut-on wavelength around 350 nm, is added in series with the interference filter. The cut-on wavelength of the interference filter shifts to shorter wavelengths with an increasing angle of incidence.

U.S. Pat. No. 5,398,133 describes the construction of near-infrared bandpass filter from a high-pass and a low-pass interference filter.

### SUMMARY

Embodiments of the present invention that are described hereinbelow provide improved devices and methods for filtering light.

There is therefore provided, in accordance with an embodiment of the present invention, an optical component, which includes an absorption-based filter having a selected cut-on wavelength, and a multilayer interference filter, arranged in series with the absorption-based filter and having a passband containing the cut-on wavelength of the absorption-based filter.

In a disclosed embodiment, the absorption-based filter includes a substrate that is transparent within at least a part of the passband of the multilayer interference filter, and the multilayer interference filter includes multiple thin film layers deposited on the substrate. Alternatively, the optical component includes a transparent substrate, wherein the absorption-based filter includes an absorbing film formed on a first side of the substrate, and the multilayer interference filter includes multiple thin film layers deposited on a second side of the substrate.

In some embodiments, the absorption-based filter includes a long-pass filter.

In other embodiments, the passband of the multilayer interference filter has a first cut-off wavelength, and the absorption-based filter includes a bandpass filter, having a second cut-off wavelength longer than the first cut-off wavelength by at least 5 nm. Additionally or alternatively, the multilayer interference filter is configured as a short-pass filter, having a cut-off wavelength longer than the cut-on wavelength of the absorption-based filter by at least 5 nm.

In still other embodiments, the cut-on wavelength of the absorption-based filter is a first cut-on wavelength, and the multilayer interference filter is configured as a bandpass filter, having a second cut-on wavelength shorter than the first cut-on wavelength of the absorption-based filter by at least 5 nm, and a cut-off wavelength longer than the cut-on wavelength of the absorption-based long-pass filter by at least 5 nm. In one embodiment, the bandpass filter is a Fabry-Perot type filter.

In some embodiments, the multilayer interference filter is configured so that a spectral distance between a cut-off wavelength of the multilayer interference filter and the cut-on wavelength of the absorption-based filter decreases, due to a spectral shift of the cut-off wavelength with angle, by at least 5% at an angle of incidence on the optical component of at least 30° relative to the spectral distance at normal incidence.

There is also provided, in accordance with an embodiment of the present invention, an optical system, including a light source, which is configured to direct optical radiation within a predefined emission band onto a target area. An imaging assembly includes an image sensor, an imaging lens, having an optical axis and configured to image the target area onto the image sensor, and a bandpass filter positioned on the optical axis in series with the imaging lens and the image sensor so as to filter rays directed from the target area toward the image sensor and having a passband that contains the emission band of the light source and narrows with increasing angle, relative to the optical axis, of the rays that are incident on the bandpass filter.

There is also provided, in accordance with an embodiment of the present invention, a method for optical filtering, including providing an absorption-based filter having a selected cut-on wavelength and arranging in series with the absorption-based filter a multilayer interference filter having a passband containing the cut-on wavelength of the absorption-based filter.

The present invention will be more fully understood from the following detailed description of the embodiments thereof, taken together with the drawings in which:

### BRIEF DESCRIPTION OF THE DRAWINGS

FIG. 1 is a schematic side view of an optical imaging system, in accordance with an embodiment of the invention;

FIG. 2 is a schematic pictorial view of a hybrid bandpass filter, in accordance with an embodiment of the invention;

FIGS. 3A-B are plots that schematically present the spectral behavior of the components of a hybrid bandpass filter, in accordance with an embodiment of the invention;

FIGS. 4A is a plot that schematically presents the shift of the cut-off wavelength of a hybrid bandpass filter with increasing angle of incidence, in accordance with an embodiment of the invention;

FIGS. 4B-G are plots that schematically illustrate performance of an imaging system at two different angles of incidence, in accordance with an embodiment of the invention;

FIG. 5 is a plot that schematically shows the impact of a hybrid filter on ambient light irradiance as a function of the image height, in accordance with an embodiment of the invention; and

FIG. 6 is a plot that schematically shows the impact of a hybrid filter on signal-to-noise ratio (SNR) as a function of the image height, in accordance with an embodiment of the invention.

### DETAILED DESCRIPTION OF EMBODIMENTS

In some depth sensing systems, a projector with a narrow-band light source projects patterned light, such as a pattern of discrete spots, onto a target area, and a receiver images the target area onto an imaging detector. The topography of the target area is derived from the lateral shift of the spot images (or other light pattern) on the imaging detector, as compared to the positions of the spots from a target area with known topography. A bandpass filter is further placed in series with the imaging lens, wherein the passband of the filter contains the emission band of the light source.

The function of the bandpass filter is to reduce the amount of ambient light reaching the imaging detector, and thus prevent the resulting decrease of the signal-to-noise ratio (SNR) of the signal measured due to the narrow-band spots. The bandpass filter is typically constructed either from two interference-based dielectric multilayer coatings on opposites sides of a substrate, with one filter being a long-pass filter and the other being a short-pass filter, or from a multilayer bandpass filter, such as a single- or multi-cavity Fabry-Perot-type filter, on one surface of the substrate. In the latter case, a supplementary coating can be deposited on the other surface of the substrate, either to provide additional attenuation outside the passband of the bandpass filter, or to function as an anti-reflective coating to enhance the transmission within the passband.

For imaging systems, additional consideration has to be given to the f-number (f/#) and to the image-height dependent chief-ray angle. A low f/# is desirable for increasing the collection efficiency of the receiver, and for simple imaging systems, the chief-ray angle depends strongly on the image height on the imaging detector. The low f/# results in the bandpass filter receiving a non-collimated beam, and the variation in the chief-ray angle results in a change in the central angle of incidence on the filter. The non-collimated beam causes the spectral edges of the bandpass filter to exhibit gentler slopes, whereas increasing the central angle of incidence shifts the entire passband to shorter wavelengths, without substantially changing the width of the passband. In other words, when the bandpass filter is constructed of long-pass and short-pass filters of the same design and materials, the cut-on and cut-off edges of the passband shift at the same rate with respect to changing ray angles. The same holds for single- and multi-cavity Fabry-Perot-type filters if they share a similar layer structure. (However, if the long-pass and short-pass filter composing the bandpass filter are of different construction, the width of the passband can change for increasing ray angles, while at the same time the center wavelength of the passband shifts to shorter wavelengths.)

In addition to interference-based coatings, material absorption can also be used for manufacturing band-pass filters. Certain dyes or inorganic compounds can be combined with an otherwise transparent material to achieve the desired optical properties. In order to achieve good transmission over a bandwidth of the order tens of nanometers, absorbing materials with a sharp absorptive profile and high transparency in their respective passbands are required. Due to the absorptive nature of these filters, the cut-on and cut-off edges are insensitive to the angle of incidence of the light passing through the filter, which leads to a spectral position and width of the passband that are insensitive to the angle of incidence.

In typical imaging optical systems, the irradiance (optical flux per unit area) of the light received by the imaging sensor falls off with increasing distance from the optical axis. In the case of the sorts of depth sensing systems noted above, this decrease of irradiance with angle applies to both the narrow-band projected pattern and the ambient light. As the irradiance from a narrow-band spot in the pattern drops, its SNR is typically reduced, since the noise scales as the square root of the signal or greater. Although the irradiance of the ambient light also drops with angle, it is still of significant magnitude, as the bandwidth of the bandpass filter remains constant over the changing chief-ray angle. This ambient light further lowers the SNR obtained from the narrow-band spots. (The signal drops due to the decrease of relative illumination of the imaging system from on-axis to off-axis. With a constant passband bandwidth, the irradiance of the ambient light will drop at the same rate as that of the signal. However, when the noise is dominated by the shot noise from the ambient light, it will be proportional to the square root of the irradiance of the ambient light. As a result, the signal-to-noise ratio (SNR) drops from on-axis to off-axis.) Thus, generally speaking, the system will have inferior SNR, and hence inferior depth sensing performance, in the peripheral areas of the field of view by comparison with the center.

Embodiments of the present invention provide a hybrid filter that can be used to achieve a further reduction in the ambient light at increasing angles of the chief ray with respect to the optical axis (i.e., increasing image heights). This filter exhibits a bandwidth that narrows with increasing chief ray angles, thus reducing the detrimental impact of the ambient light on the SNR at high chief ray angles (i.e., large image heights). Although embodiments of the present invention are illustrated using a chief ray angle of 30°, this is not a limitation of the maximal chief ray angle, and larger or smaller maximal angles may alternatively be used depending on system requirements.

In the embodiments described below, the hybrid bandpass filter has a cut-on edge defined by the cut-on edge of an absorbing filter, and a cut-off edge is defined by an interference filter, arranged in series with the absorption-based filter, having a multilayer coating defining a passband that contains the cut-on wavelength of the absorption-based filter. The cut-on edge of this hybrid bandpass filter is insensitive to the angles of incidence, due to the absorptive nature of the material forming it, whereas the cut-off edge shifts to shorter wavelengths with increasing angles of incidence, due to the inherent interference-based construction of the multilayer coating. This filter design has the overall effect of narrowing the width of the passband with increasing angles of incidence. In an alternative embodiment (not shown in the figures), the bandpass filter may comprise long-pass and short-pass interference filters of different construction, chosen so that the width of the passband decreases with increasing ray angles.

When used in a narrow-band imaging system, such as the pattern-based depth sensing systems described above, the hybrid filter reduces the irradiance of ambient light on the image detector with increasing image height. At the same time, the spectral location of the fixed cut-on edge of the bandpass filter and the spectral location of the cut-off edge at maximal spectral shift (due to the maximal chief ray angle, corresponding to maximal image height) are chosen so that the signal from the narrow-band pattern passes the bandpass filter without appreciable attenuation throughout the entire range of incidence angles. The irradiance from both the narrow-band pattern and the ambient light is attenuated for increasing chief ray angles, due to the effects of the imaging optics, but the additional attenuation of the ambient light with increasing chief ray angles that is provided by the hybrid bandpass filter mitigates the loss of signal and thus reduces the overall degradation of SNR at high angles.

Although the disclosed embodiments make reference particularly to the use of the present hybrid filter in certain sorts of 3D imaging applications based on patterned light, the principles of the present invention are applicable in other situations in which a selective narrowing of the passband of a bandpass filter, as a function of angle of incidence, is desired.

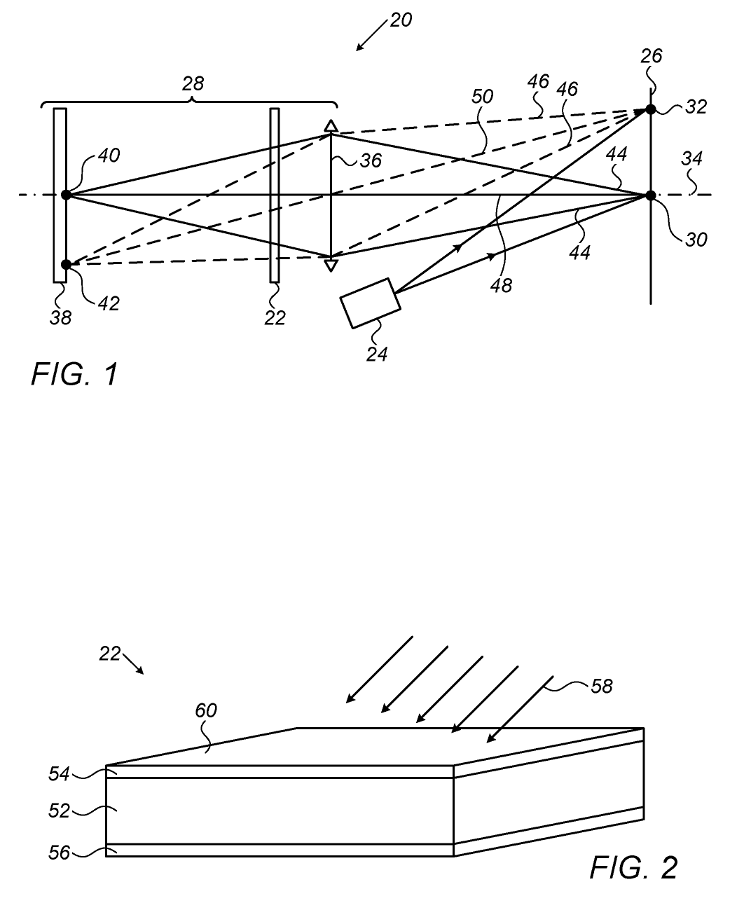

FIG. 1 is a schematic side view of an optical imaging system 20 that makes use of a hybrid bandpass filter 22, in accordance with an embodiment of the present invention. Filter 22 comprises a suitable substrate, such as a transparent or selectively absorbing glass plate, with one or more coatings chosen to give the filter the desired behavior, as described further hereinbelow. A projector 24, comprising a narrow-band light source and an appropriate spatial modulator, projects a narrow-band pattern onto a target area 26. A receiver 28 incorporating filter 22 captures an image of the pattern.

The functioning of receiver 28 is demonstrated using two points 30 and 32 in the target area, with point 30 being an axial point (a point on an optical axis 34 of the receiver), and point 32 being an off-axis point. Target area 26 is imaged by receiver 28, which comprises an imaging lens 36, hybrid bandpass filter 22, and an image sensor 38 such as a CCD array or CMOS array. As an example, points 30 and 32 are imaged, respectively, to image points 40 and 42 on image sensor 38. For the purpose of illustration, imaging lens 36 is here shown as a single thin lens, with the aperture stop of receiver 28 formed by the lens, but more complex imaging systems, possibly comprising both refractive and reflective elements may alternatively be used. For points 30 and 32, respective pairs of marginal rays 44 and 46, through the edges of imaging lens 36, and chief rays 48 and 50, through the center of the imaging lens, are shown. Chief ray 48 from axial point 30 coincides with optical axis 34. As shown in the figure, the angle of the chief ray with respect to the optical axis increases with increasing image height.

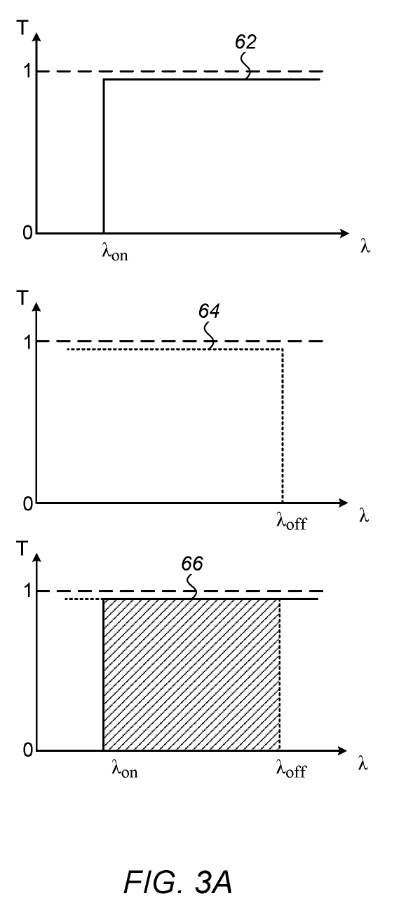

FIG. 2 is a schematic representation of hybrid bandpass filter 22, in accordance with an embodiment of the present invention. Filter 22 comprises a plate substrate 52, and one or two coatings 54 and 56 on the substrate. Light 58 to be transmitted by the filter impinges on an entrance face 60 of the filter and traverses the filter through the coatings and the substrate. At least one of the coatings, for example, coating 54, is a multilayer interference filter with spectrally selective transmission. Either the other coating, such as coating 56, or substrate 52, or both the other coating and the substrate are absorbing filters with spectrally selective transmission. In the case in which substrate 52 is an absorbing filter, one of the coatings, such as coating 54, is still a multilayer interference filter, but the other coating may be, for example, an antireflective coating to increase the transmission in the transmission band, or a coating providing additional transmission suppression outside the transmission band.

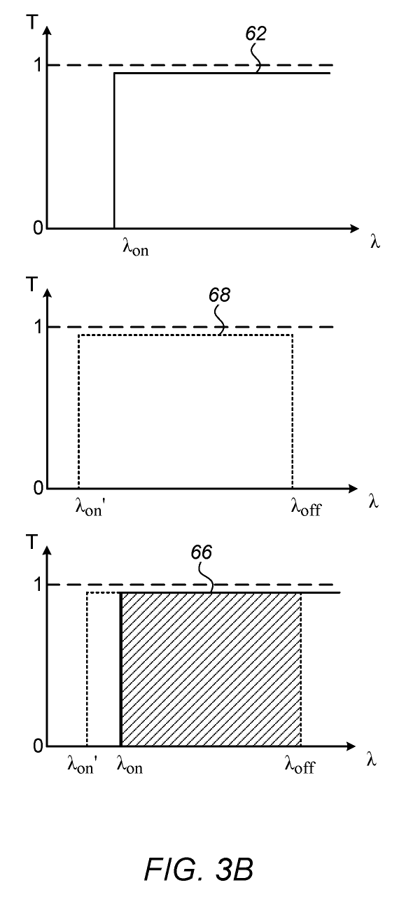

FIGS. 3A-B are plots that schematically present the spectral behavior of the components of hybrid bandpass filter 22, in accordance with an embodiment of the invention. In the graphs of FIGS. 3A-B, as well as in subsequent graphs, T refers to the transmission coefficient and λ refers to wavelength.

FIG. 3A shows spectral characteristics of a hybrid filter constructed from a high-pass filter and a low-pass filter arranged in series, in accordance with an embodiment of the invention. The high-pass filter, with a transmission spectrum 62, is an absorption-based filter, having a cut-on wavelength λₒₙ. This filter has low transmission, ideally zero but in practice less than 1%, for example, below the cut-on wavelength, and high transmission, ideally 100% but in practice above 90%, for example, above the cut-on wavelength. Due to the finite spectral width of the transition of the filter transmission between its minimum transmission and maximum transmission values, the cut-on wavelength is by convention defined as the location where the transmission reaches half of its maximum value.

The low-pass filter with a transmission spectrum 64, is a multilayer interference filter, with a cut-off wavelength λ_{off}. This filter has high transmission, ideally 100% but in practice above 90%, for example, below the cut-off wavelength, and low transmission, ideally zero but in practice less than 1%, for example, above the cut-off wavelength. Similarly to the cut-on wavelength of the high-pass filter, the cut-off wavelength is in practice defined at the half-maximum point of the transmission transition. The cut-off wavelength of this low-pass interference filter is greater than the cut-on wavelength of the absorption-based filter, and therefore the passband of the interference filter, as illustrated by spectrum 64, contains the cut-on wavelength of the absorption-based filter having spectrum 62.

Combining the two filters and the substrate as shown in FIG. 2 will result in a bandpass filter with a transmission spectrum 66, having a transmission band defined by the wavelengths λₒₙ and λ_{off}.

FIG. 3B shows spectral characteristics of a hybrid filter constructed from a high-pass filter and a bandpass filter, in accordance with another embodiment of the invention. The high-pass filter is an absorption-based filter, as in FIG. 3A. The bandpass filter, with a transmission spectrum 68, is a multilayer bandpass interference filter, with cut-on wavelength λₒₙ′ and cut-off wavelength λ_{off}. The cut-off wavelength of the bandpass interference filter is again greater than the cut-on wavelength of the absorption-based filter, and therefore the passband of the interference filter, as illustrated by spectrum 68, contains the cut-on wavelength of the absorption-based filter having spectrum 62. Typically, λₒₙ′ is shorter than λₒₙ by at least 5 nm, in order to prevent the cut-on edge of the interference filter at λₒₙ′ from affecting the cut-on edge of the absorption-based filter at λₒₙ. Combining the two filters and the substrate as shown in FIG. 2 will result in a bandpass filter with transmission spectrum 66, with the transmission band defined by the wavelengths λₒₙ and λ_{off}.

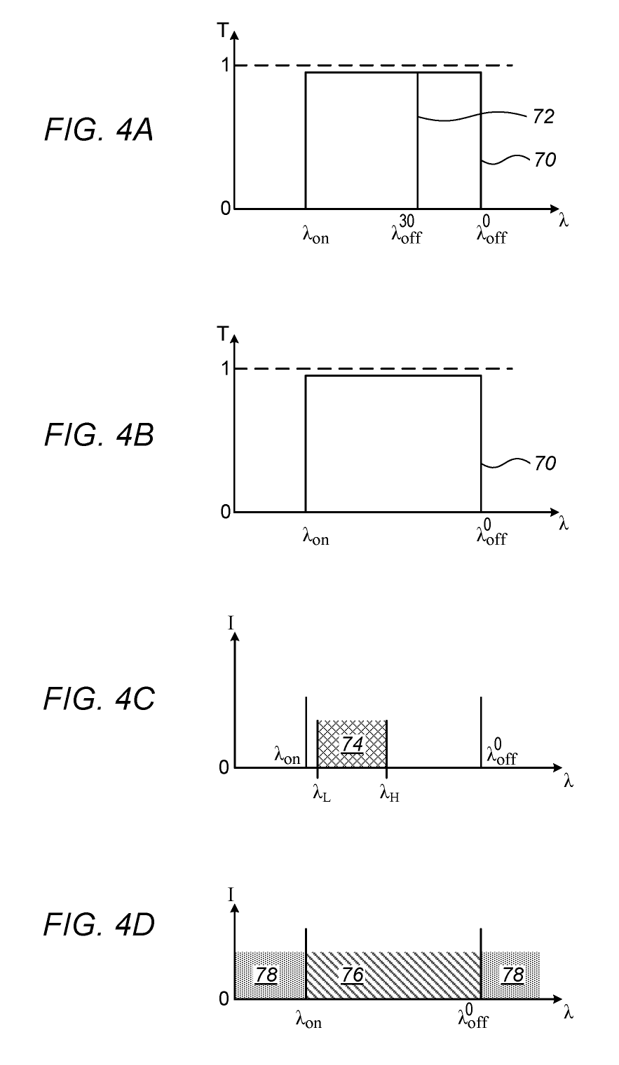

FIGS. 4A-G are plots that schematically illustrate the functioning of a hybrid bandpass filter in accordance with an embodiment of the present invention.

FIG. 4A shows the behavior of the passband of the hybrid filter when the direction of the light impinging on the filter changes from 0° (normal incidence) to an oblique angle, such as 30° from normal. Due to the fact that the cut-on wavelength λₒₙ is determined by the cut-on wavelength of an absorbing filter, it is insensitive to the angle of incidence, and the cut-on edge of the hybrid bandpass filter does not move with increasing angles of incidence. However, the cut-off wavelength λ_{off} is determined by the cut-off wavelength of a multilayer interference filter. As explained above, the spectral characteristics, such as cut-on and cut-off wavelengths, of such interference filters shift to shorter wavelengths as the angle of incidence increasingly departs from normal. A cut-off wavelength 70 of the hybrid bandpass filter is located at wavelength λ_{off}⁰ for normally incident light, whereas for light incident at 30° from the normal, a shifted cut-off wavelength 72 has moved to wavelength λ_{off}³⁰, which is shorter than λ_{off}⁰.

Typically, the multilayer interference filter and the absorption-based filter are configured so that the spectral shift of the dielectric multilayer filter, from cut-off wavelength 70 at normal incidence to cut-off wavelength 72 at 30° incidence, causes the spectral distance between the cut-off wavelength and the cut-on wavelength of the absorption-based filter (i.e., the bandwidth of the passband) to decrease by at least 5% over this angular range. In an embodiment of the present invention, the bandwidth of the passband is 44 nm at zero-degree angle of incidence. With an increase of the angle of incidence to 30°, the cut-off edge of the passband shifts by 12 nm towards shorter wavelengths. Assuming that the cut-on edge does not shift with angle of incidence, the passband reduces from 44 nm to 32 nm, a decrease of 27%.

FIGS. 4B-D show, at zero-degree angle of incidence, the interaction between passband 70 of the hybrid filter (FIG. 4B), an emission spectrum 74 of the light source in projector 24 (FIG. 4C), and the spectrum of the ambient light in the environment of system 20 (FIG. 4D). FIGS. 4C-D show the spectra in arbitrary units of irradiance I, without reference to specific values of irradiance. FIG. 4B shows the passband of the hybrid filter, with the fixed cut-on edge located at λₒₙ, and the angle-dependent cut-off located in its zero-degree position 70 at λ_{off}⁰. FIG. 4C shows, in the same wavelength scale as FIG. 4B, emission spectrum 74 of the narrow-band light source in projector 24, extending from a minimum wavelength λ_{L} to a maximum wavelength λ_{H}. These wavelength limits are determined by the typical variations of the emission wavelengths of common transmitters, such as semiconductor lasers. The wavelengths can vary within certain ranges, due to such factors as production tolerances and temperature, as well as due to modulation-related band widening.

Typically, in embodiments of the present invention, spectrum 74 from λ_{L} to λ_{H} is in its entirety within passband 70 of the hybrid filter. FIG. 4D shows, in the same wavelength scale as FIGS. 4B-C, the spectrum of the ambient light, which is typically much broader than the passband of the hybrid filter. The hybrid filter transmits a portion 76 of the ambient light in the spectral range between the wavelengths λₒₙ and λ_{off}⁰, and rejects any portion 78 of the spectrum outside this passband.

FIGS. 4E-G show, at an angle of incidence of 30°, the interaction between passband 72 of the hybrid filter (FIG. 4E), emission spectrum 74 of the light source in projector 24 (FIG. 4F), and the spectrum of the ambient light (FIG. 4G). FIG. 4E shows the narrowing of passband 72 of the hybrid filter, with the fixed cut-on edge still located at λₒₙ, while the angle-dependent cut-off has now moved to its 30° position at λ_{off}³⁰. FIG. 4F shows, in the same wavelength scale as FIG. 4E, emission spectrum 74 of the light source against the passband of the hybrid filter at angle of incidence of 30°. In the present embodiment, the cut-off edge of the hybrid filter is designed in such a way that with the highest angle of incidence of the reflected light on hybrid filter 22, the emission spectrum of the light source is still completely contained within the passband of the hybrid filter. This requirement further sets a lower limit to passband 70 of the hybrid filter at 0° angle of incidence, as passband 70 is required to accommodate both emission spectrum 74 of the light source and the narrowing of passband 70 to passband 72 at 30° angle of incidence. Typically, passband 70 is at least 5 nm.

FIG. 4G shows, in the same wavelength scale as FIGS. 4E-F, the spectrum of the ambient light. Due to the shift of the cut-off edge of passband 72 of the hybrid filter to its position at λ_{off}³⁰<λ_{off}⁰, a portion of the ambient light that is transmitted by the hybrid filter is reduced relative to the zero-degree incidence portion 76, thus reducing the amount of ambient light reaching the image detector, while a greater portion 82 of the ambient light spectrum is rejected.

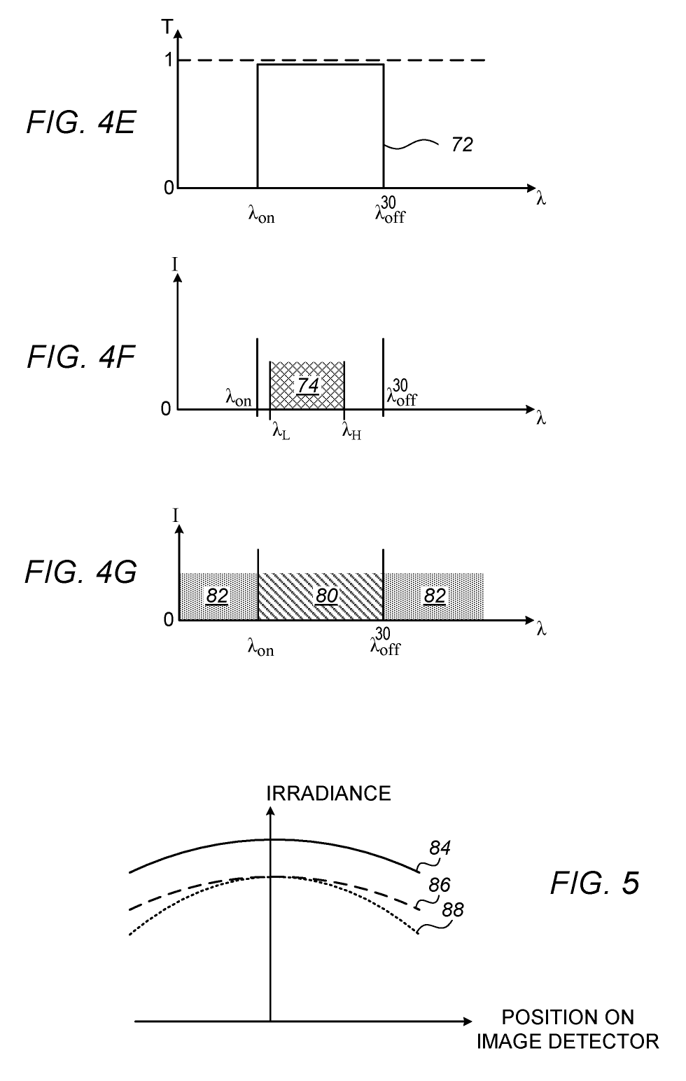

FIG. 5 is a plot that schematically shows the effect of hybrid bandpass filter 22 on the irradiance of received light on image sensor 38, in accordance with an embodiment of the invention. For the sake of comparison, the effect of a conventional bandpass filter is included. The curves shown in FIG. 5 depict the irradiance on the image detector vs. the position on the image detector, i.e., image height.

Due to well-known effects in imaging optics, the irradiance in general diminishes from the center of image sensor 38, corresponding to optical axis 34 of receiver 28, towards the edges of the sensor, corresponding to increasing chief ray angles. This phenomenon is shown as the decay, as a function of angle, of a narrow-band signal 84 received by image sensor 38 in the emission band of projector 24. If one were to use a conventional bandpass filter, whose passband width is independent of the angle of the impinging light, the irradiance of ambient light 86 would follow a similar decay.

The impact of hybrid bandpass filter 22, however, is to impose a further reduction in the irradiance of the ambient light, due to the narrowing bandwidth available for the ambient light with increasing angle, with a resulting irradiance behavior 88. In this manner, the impact of ambient light on the SNR of the desired measurement signal is further reduced at increasing chief ray angles, where the available SNR of the useful signal otherwise tends to diminish.

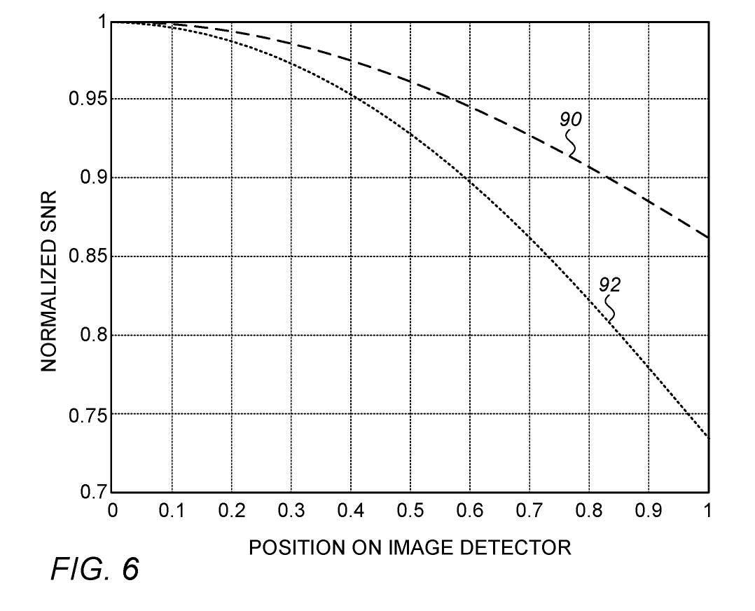

FIG. 6 is a plot that schematically shows the impact of a hybrid filter on a calculated SNR of image sensor 38 as a function of the image height, in accordance with an embodiment of the invention. FIG. 6 shows a comparison between a SNR of a standard bandpass filter 90 and a SNR of an embodiment of the present invention 92. The horizontal axis of the graph refers to a relative image height from on-axis position (zero-degree chief ray angle) to maximal image height (maximal chief ray angle). The vertical axis presents a calculated SNR for an embodiment, relative to SNR for an on-axis field point. At the maximal chief ray angle (maximal image height), for a conventional infra-red filter, SNR 90 would drop to 74% of its maximal value at zero-degree chief ray angle (at an on-axis image point). However, using a hybrid filter in accordance with an embodiment of the present invention, SNR 92 drops to no lower than 86% of its maximal value.

Although the embodiments described above relate specifically to the use of a hybrid bandpass filter in mitigating the effect of ambient light in a narrowband imaging system, such hybrid filters, whose bandwidth changes with angle, may similarly be used in other imaging, sensing and illumination applications. It will thus be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. An optical component, comprising:
an absorption-based filter having a selected cut-on wavelength; and
a multilayer interference filter, arranged in series with the absorption-based filter and having a passband containing the cut-on wavelength of the absorption-based filter.

2. The optical component according to claim 1, wherein the absorption-based filter comprises a substrate that is transparent within at least a part of the passband of the multilayer interference filter, and the multilayer interference filter comprises multiple thin film layers deposited on the substrate.

3. The optical component according to claim 1, and comprising a transparent substrate, wherein the absorption-based filter comprises an absorbing film formed on a first side of the substrate, and the multilayer interference filter comprises multiple thin film layers deposited on a second side of the substrate.

4. The optical component according to claim 1, wherein the absorption-based filter comprises a long-pass filter.

5. The optical component according to claim 1, wherein the passband of the multilayer interference filter has a first cut-off wavelength, and wherein the absorption-based filter comprises a bandpass filter, having a second cut-off wavelength longer than the first cut-off wavelength by at least 5 nm.

6. The optical component according to claim 1, wherein the multilayer interference filter is configured as a short-pass filter, having a cut-off wavelength longer than the cut-on wavelength of the absorption-based filter by at least 5 nm.

7. The optical component according to claim 1, wherein the cut-on wavelength of the absorption-based filter is a first cut-on wavelength, and wherein the multilayer interference filter is configured as a bandpass filter, having a second cut-on wavelength shorter than the first cut-on wavelength of the absorption-based filter by at least 5 nm, and a cut-off wavelength longer than the cut-on wavelength of the absorption-based long-pass filter by at least 5 nm.

8. The optical component according to claim 7, wherein the multilayer interference filter comprises a Fabry-Perot-type filter.

9. The optical component according to claim 1, wherein the multilayer interference filter is configured so that a spectral distance between a cut-off wavelength of the multilayer interference filter and the cut-on wavelength of the absorption-based filter decreases, due to a spectral shift of the cut-off wavelength with angle, by at least 5% at an angle of incidence on the optical component of at least 30° relative to the spectral distance at normal incidence.

10. An optical system, comprising:
a light source, which is configured to direct optical radiation within a predefined emission band onto a target area; and
an imaging assembly, comprising:
an image sensor;
an imaging lens, having an optical axis and configured to image the target area onto the image sensor; and
a bandpass filter positioned on the optical axis in series with the imaging lens and the image sensor so as to filter rays directed from the target area toward the image sensor and having a passband that contains the emission band of the light source and narrows with increasing angle, relative to the optical axis, of the rays that are incident on the bandpass filter.

11. The optical system according to claim 10, wherein the bandpass filter comprises:
an absorption-based filter having a selected cut-on wavelength; and
a multilayer interference filter, arranged in series with the absorption-based filter and having a passband containing the cut-on wavelength of the absorption-based filter.

12. A method for optical filtering, comprising:
providing an absorption-based filter having a selected cut-on wavelength; and
arranging in series with the absorption-based filter a multilayer interference filter having a passband containing the cut-on wavelength of the absorption-based filter.

13. The method according to claim 12, wherein the absorption-based filter comprises a substrate that is transparent within at least a part of the passband of the multilayer interference filter, and wherein arranging the multilayer interference filter comprises depositing multiple thin film layers on the substrate.

14. The method according to claim 12, wherein providing the absorption-based filter comprises forming an absorbing film formed on the first side of a transparent substrate, and wherein arranging the multilayer interference filter comprises depositing multiple thin film layers on a second side of the substrate.

15. The method according to claim 12, wherein the absorption-based filter comprises a long-pass filter.

16. The method according to claim 12, wherein the passband of the multilayer interference filter has a first cut-off wavelength, and wherein the absorption-based filter comprises a bandpass filter, having a second cut-off wavelength longer than the first cut-off wavelength by at least 5 nm.

17. The method according to claim 12, wherein the multilayer interference filter is configured as a short-pass filter, having a cut-off wavelength longer than the cut-on wavelength of the absorption-based filter by at least 5 nm.

18. The method according to claim 12, wherein the cut-on wavelength of the absorption-based filter is a first cut-on wavelength, and wherein the multilayer interference filter is configured as a bandpass filter, having a second cut-on wavelength shorter than the first cut-on wavelength of the absorption-based filter by at least 5 nm, and a cut-off wavelength longer than the cut-on wavelength of the absorption-based long-pass filter by at least 5 nm.

19. The method according to claim 18, wherein the multilayer interference filter comprises a Fabry-Perot-type filter.

20. The method according to claim 12, wherein the multilayer interference filter is configured so that a spectral distance between a cut-off wavelength of the multilayer interference filter and the cut-on wavelength of the absorption-based filter decreases, due to a spectral shift of the cut-off wavelength with angle, by at least 5% at an angle of incidence on the optical component of at least 30° relative to the spectral distance at normal incidence.
